(19) United States
(12) Patent Application Publication
(10) Pub. No.: US 2018/0043514 A1
(43) Pub. Date: Feb. 15, 2018

(54) INTERFERENCE FIT SCREWDRIVER TIP AND POWERED SCREWDRIVER USING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: JUN FENG, Shenzhen (CN); WEI WU, Shenzhen (CN)

(21) Appl. No.: 15/673,419

(22) Filed: Aug. 10, 2017

(30) Foreign Application Priority Data
Aug. 10, 2016 (CN) 201610650528.2

(51) Int. Cl. B25B 23/10; B25B 21/00

(52) U.S. Cl. CPC B25B 23/108; B25B 21/00

(57) ABSTRACT

A powered screwdriver includes a handle, a bit, and a tip. The bit has two ends, one of which ends is attached to the handle. The tip is located at the other end of the bit, and the tip has an engaging portion and at least one resilient member. The engaging portion has at least one end. The at least one resilient member is attached to the at least one end of the engaging portion. The engaging member engages into a slot of a screw head firmly by an interference fit between the resilient member and surfaces of the slot. The method of an interference fit into the screw head is suitable for all types and conditions of screws.

### CROSS REFERENCE TO RELATED APPLICATION

This application claims priority to Chinese Patent Application No. 201610650528.2, filed Aug. 10, 2016, the disclosure of which is incorporated herein by reference in its entirety.

### FIELD

The present disclosure relates to powered screwdrivers, and more particularly to an interference fit screwdriver tip and a powered screwdriver using the same.

### BACKGROUND

A conventional method for securing and screwing a screw head is to use a magnetic screwdriver tip to attract the screw. However, the method of using the magnetic screwdriver tip is not suitable for non-magnetic elements.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a top perspective view of a powered screwdriver.

FIG. 2 is an enlarged view of the area II of FIG. 1.

FIG. 3 is an enlarged bottom perspective view of a screwdriver tip of the powered screwdriver of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

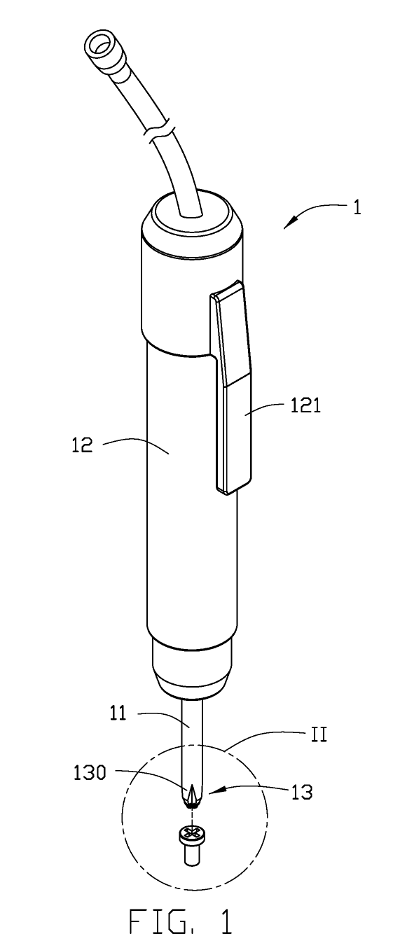

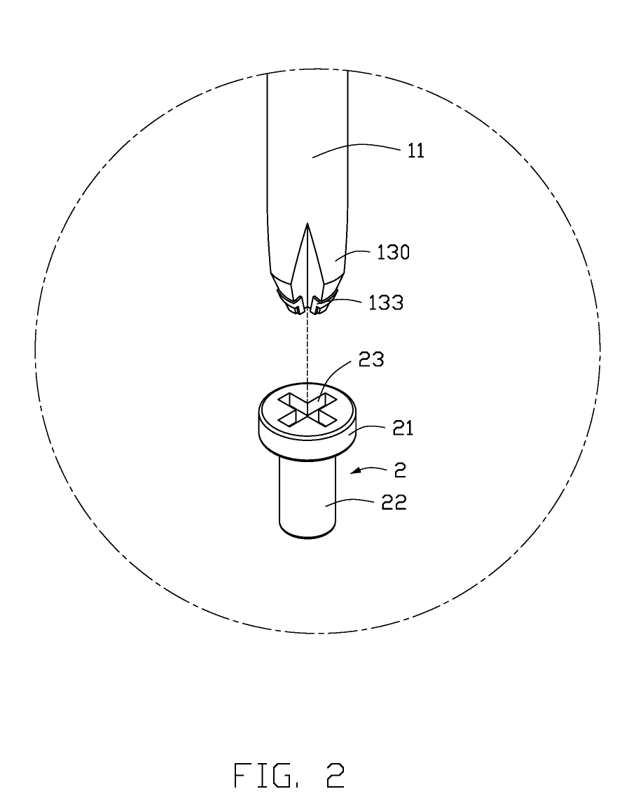

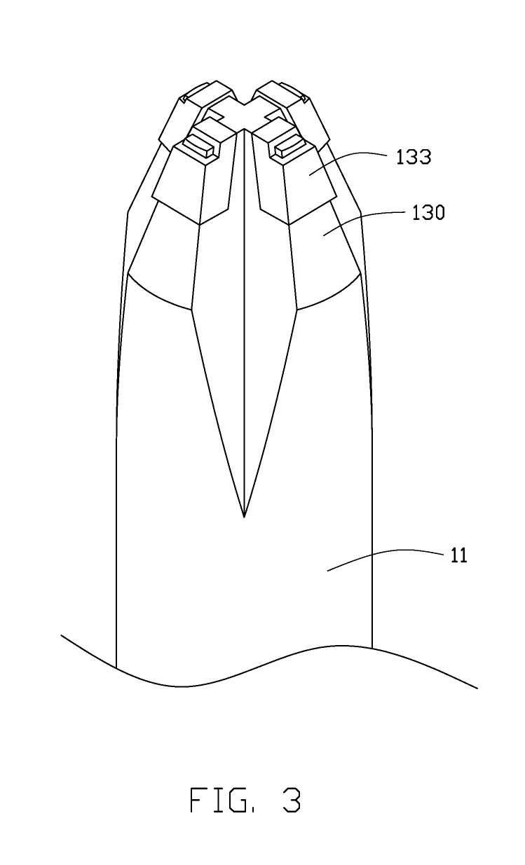

With reference to FIG. 1, an exemplary embodiment of a powered screwdriver 1 includes a handle 12, a bit 11, and a tip 13. The bit 11 has two ends. One end of the bit 11 is attached to the handle 12, and the tip 13 is located at the other end of the bit 11. With reference to FIGS. 2 and 3, the tip 13 has an engaging portion 130 and at least one resilient member 133.

The engaging portion 130 has at least one end. In the present exemplary embodiment, the engaging portion 130 is cross-shaped and therefore has four ends. In other exemplary embodiments, the engaging portion 130 is flat and has two ends.

The number of the at least one resilient members 133 is equal to the number of the at least one end of the engaging portion 130. The at least one resilient member 133 corresponds to and is attached to the at least one end of the engaging portion 130. The engaging portion 130 is made of cemented carbide, and the resilient member 133 is made of a resilient plastic or a resilient metal. In the present exemplary embodiment, the resilient member 133 is a wedge-shaped block.

With reference to FIG. 1, in the present exemplary embodiment, the handle 12 has a switch 121 for a user to actuate the powered screwdriver 1.

With reference to FIG. 2, in the present exemplary embodiment, the powered screwdriver 1 is used for turning a screw 2. The screw 2 has a screw shank 22 and a screw head 21 with a cross slot 23. The engaging member 130 can be inserted into the cross slot 23 of the screw head 21 by an interference fit between the resilient member 133 and surfaces of the cross slot 23, thus achieving a precision fit and total engagement. The method of using the tip 13 to insert into the screw head 21 as an interference fit is suitable for all types and conditions of screws 2.

The exemplary embodiments shown and described above are only examples. Many details are often found in the art such as the other features of a powered screwdriver. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A screwdriver tip comprising:
an engaging portion having at least one end; and
at least one resilient member;
wherein the at least one resilient member corresponds to and is attached to the at least one end of the engaging portion.

2. The screwdriver tip of claim 1, wherein the engaging portion is made of cemented carbide.

3. The screwdriver tip of claim 1, wherein the resilient member is made of a resilient plastic.

4. The screwdriver tip of claim 2, wherein the resilient member is made of a resilient plastic.

5. The screwdriver tip of claim 1, wherein the resilient member is made of a resilient metal.

6. The screwdriver tip of claim 2, wherein the resilient member is made of a resilient metal.

7. The screwdriver tip of claim 3, wherein the resilient member is made of a resilient metal.

8. The screwdriver tip of claim 4, wherein the resilient member is made of a resilient metal.

9. The screwdriver tip of claim 1, wherein the resilient member is a wedge-shaped block.

10. The screwdriver tip of claim 2, wherein the resilient member is a wedge-shaped block.

11. A powered screwdriver comprising:
a handle;
a bit having two ends, one of which attached to the handle; and
a tip located at the other end of the bit, and having:
an engaging portion having at least one end; and
at least one resilient member;
wherein the at least one resilient member corresponds to and is attached to the at least one end of the engaging portion.

12. The powered screwdriver of claim 11, wherein the engaging portion is made of cemented carbide.

13. The powered screwdriver of claim 11, wherein the resilient member is made of a resilient plastic.

14. The powered screwdriver of claim 12, wherein the resilient member is made of a resilient plastic.

15. The powered screwdriver of claim 11, wherein the resilient member is made of a resilient metal.

16. The powered screwdriver of claim 12, wherein the resilient member is made of a resilient metal.

17. The powered screwdriver of claim 13, wherein the resilient member is made of a resilient metal.

18. The powered screwdriver of claim 14, wherein the resilient member is made of a resilient metal.

19. The powered screwdriver of claim 11, wherein the resilient member is a wedge-shaped block.

20. The powered screwdriver of claim 12, wherein the resilient member is a wedge-shaped block.
